(19) United States
(12) Patent Application Publication
(10) Pub. No.: US 2006/0222777 A1
(43) Pub. Date: Oct. 5, 2006

(54) Method for applying a plasma sprayed coating using liquid injection

(75) Inventors: Andrew Jay Skoog, West Chester, OH (US); Jane Ann Murphy, Franklin, OH (US); Thomas John Tomlinson, West Chester, OH (US)

Correspondence Address: MCNEES WALLACE & NURICK LLC, 100 PINE STREET, P.O. BOX 1166, HARRISBURG, PA, 17108-1166, US

(73) Assignee: GENERAL ELECTRIC COMPANY, Schenectady, NY (US)

(21) Appl. No.: 11/099,264

(22) Filed: Apr. 5, 2005

(51) Int. Cl. C23C 4/00; H05H 1/26; B05D 1/08; B05B 5/025

(52) U.S. Cl. 427/446; 118/629

(57) ABSTRACT

A method for applying a plasma prayed coating using liquid injection is disclosed. The method includes providing a mixture of a liquid and solid particles. The solid particles are constituents of a thermal barrier coating. The mixture is injected into a plasma jet of a plasma spray device and the plasma jet is directed toward a substrate to deposit a gradient film formed from the constituents onto the substrate.

### FIELD OF THE INVENTION

The present invention is directed to methods for applying plasma sprayed coatings using plasma spraying techniques onto a substrate and more particularly to a plasma spray technique that employs a liquid injection to apply a coating to a substrate.

### BACKGROUND OF THE INVENTION

A thermal barrier coating system (or “TBC”) is deposited onto gas turbine and other heat engine parts to reduce heat flow and to improve thermal performance of the metal parts. To be effective, a TBC must have low thermal conductivity, strongly adhere to the part and remain adherent throughout many heating and cooling cycles (thermal cycling). New gas turbine designs push the limits of current coating capability, particularly with regard to high temperature sintering, thermal conductivity and resistance to erosion, impact, corrosion and thermal fatigue. Hence, there is a great interest in improving thermal barrier coatings to permit operation of turbine engines at higher temperatures and to extend turbine engine part life.

Standard plasma spray technology primarily uses powder feeders to deliver powdered coating material into a plasma jet of a plasma spray gun. However, this technology is typically limited to the use of particles of at least 200 mesh or larger. As particle size decreases below 200 mesh, introducing powdered coating material directly into the plasma jet becomes progressively more difficult. Fine particles tend to pack tightly, increasing the likelihood of clogging in conventional powder feed systems. Fine particles are desired for use in thermal barrier coatings, however, as the fine particles typically result in finer grain, denser coatings. Fine particles are also easier to melt because of the thermal properties of a fine particle compared to its small mass.

In addition to clogging, conventional technology is also ill-suited to the use of fine particles for other reasons. Because of the low mass of fine particles, combined with the extreme velocities of the plasma jet, fine particles tend to be deflected away from a boundary layer of the plasma jet without penetrating the boundary layer. The velocity at which the fine particles are introduced into the jet can be increased to overcome the boundary layer, but this velocity is high enough that the particles then have a tendency to pass entirely through the plasma jet, rather than being swept into the plasma jet to be melted and deposited as the coating.

Accordingly, it may be desirable to provide a method to apply a plasma-sprayed coating to a substrate that uses fine particles to produce a coating that overcomes these and other disadvantages of current plasma spray technology.

### SUMMARY OF THE INVENTION

According to an embodiment of the invention, a method for applying a plasma sprayed coating is disclosed. The method comprises providing a suspension comprising a carrier liquid and solid particles suspended therein, the solid particles including thermal barrier coating constituents, injecting the suspension into a plasma jet of a plasma spray device and directing the plasma jet toward a substrate to deposit a gradient film formed from the constituents onto the substrate.

According to another embodiment of the invention, another method for applying a plasma sprayed coating is also disclosed. The method comprises providing a liquid/solid mixture comprising a carrier liquid and solid particles intermixed therewith, the solid particles including thermal barrier coating constituents, providing particulate thermal barrier coating constituents other than in a liquid/solid mixture, separately injecting the liquid/solid mixture and the particulate thermal barrier coating constituents into a plasma jet of a plasma spray device and directing the plasma jet toward a substrate to deposit a gradient film formed from the constituents onto the substrate.

One advantage of methods according to embodiments of the present invention is that the use of a liquid injection of coating constituents with plasma spray techniques permits the use of fine particles as coating constituents. This results in coatings that are denser than those achievable by conventional methods. The coatings also exhibit a finer grain size.

Another advantage of the present invention is that using a liquid injection to deliver coating constituents with plasma spray techniques increases the percentage of constituents that enter the plasma jet, decreasing the amount of bounce-back and/or pass-through of particles through the plasma jet, thereby increasing process efficiency. The liquid tends to stabilize the fine particles in the plasma stream, allowing liquid carrier to vaporize and the fine particles to be caught up in the plasma stream.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 illustrates a system for applying a plasma sprayed coating according to an embodiment of the invention.

FIG. 2 illustrates an enlarged view of the torch portion of the plasma gun of FIG. 1.

FIG. 3 illustrates an enlarged view of the torch portion of the plasma gun of FIG. 1 for use in applying a plasma sprayed coating according to another embodiment of the invention.

FIG. 4 diagrammatically depicts a method for applying a plasma sprayed coating according to an exemplary embodiment of the invention.

FIG. 5 illustrates an alternative embodiment of the torch portion of the plasma gun shown in FIG. 3 having multiple injectors.

### DETAILED DESCRIPTION OF THE INVENTION

Embodiments of the present invention are directed to methods of applying plasma sprayed coatings to a substrate by using a plasma spray device having a liquid injection system to inject coating constituents into the plasma jet. While exemplary embodiments of the invention are primarily discussed with respect to suspensions, any liquid/solid mixture may be used. Solutions of solids dissolved in liquids may also be used.

By the term “suspension” is meant all heterogeneous mixtures in which solid particles are intermixed with a liquid, whether or not those particles would settle out over time; that is, regardless of whether the suspension is or is not colloidal. By “liquid/solid mixture” is meant all mixtures, whether homogeneous or heterogeneous, in which solid particles are intermixed with a liquid, including, but not limited to, suspensions and solutions.

Any kind of plasma spray device may be used to carry out the methods of the invention, although exemplary embodiments of the invention are discussed particularly with respect to plasma guns typically used in air plasma spray (APS) processes. Furthermore, the methods described herein may be used with robotically controlled plasma guns or with hand-held plasma guns for manual application of coatings to a desired location.

Plasma spray processes, such as those used in APS and low-pressure plasma spray (LPPS), are well known methods for applying coatings to articles by introducing solid particles into a plasma flame of a plasma gun. A plasma forming gas, usually nitrogen or argon, is introduced into and passed through the plasma gun. Prior to exiting the gun, the plasma forming gas passes through an electric arc created by a large direct current. This results in an extreme amount of thermal energy sufficient to cause the gas to change state into a plasma, charged particles moving at a high velocity, which leaves the gun as a plasma jet, typically at velocities of 600 or more meters per second. In conventional processes, particulate coating constituents are introduced into the plasma jet via a carrier gas, melted or partially melted, and propelled by the plasma jet onto a substrate where the particles cool and resolidify to form a coating.

As discussed previously, conventional plasma spray processes introduce particles into the plasma jet via a carrier gas, but for various reasons, are typically limited to powders having a particle size of 200 mesh or larger. Particles smaller than 200 mesh tend to clog conventional feeders. Furthermore, those particles which do pass from the feeder are of such small mass that they tend to bounce off a boundary layer of the plasma jet exiting the plasma gun. Increasing the velocity of the particles and carrier gas introduced into the plasma flame may overcome the boundary layer problem, but increases the likelihood of a clogged feeder and causes a significant amount of the particles to shoot through the plasma stream and pass out the other side, resulting in a loss of raw materials and inefficient application of the coating. Exemplary embodiments of the present invention overcome these and other deficiencies by introducing the coating constituents into the plasma stream by liquid injection, usually applied over a conventional bond coat, such as a MCrAlY system, applied to a substrate.

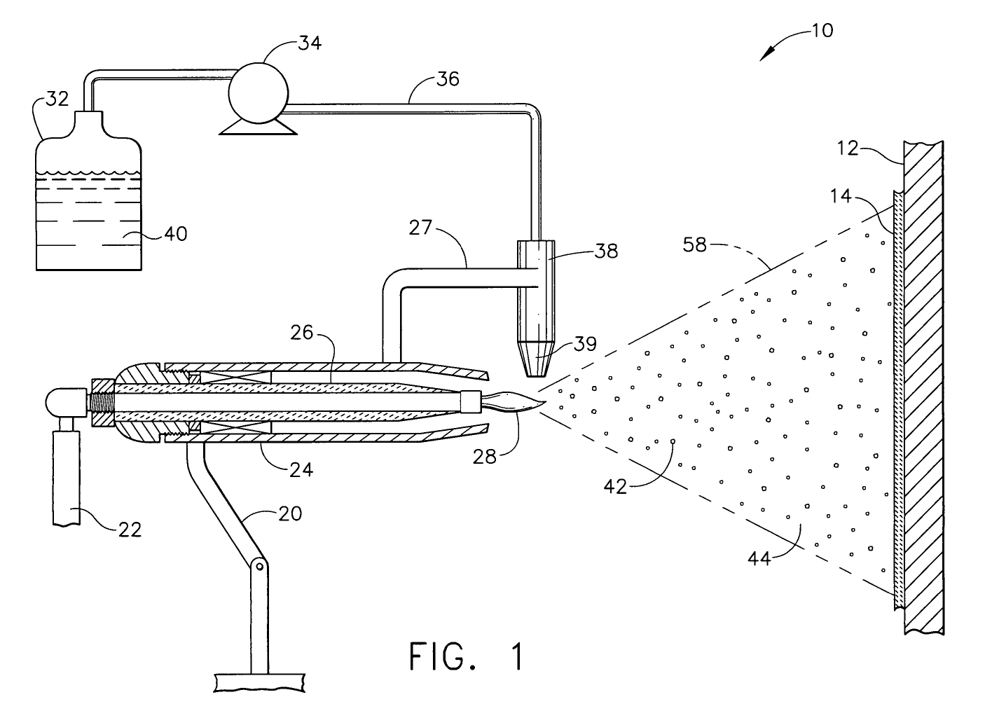

Referring now to FIG. 1, a system 10 for applying a coating to a substrate by plasma spray in accordance with an exemplary embodiment of the invention is shown. A plasma gun 20 is used to apply thermal barrier coating constituents 42 to create a thermal barrier coating system 14 of one or more coatings on a substrate 12. A plasma forming gas is introduced into the plasma gun 20 by a gas line 22 carrying the plasma forming gas to the plasma gun 20. The plasma forming gas is passed into a torch portion 24 of the plasma gun 20. An electric arc, typically operating at 40 or 80 kW, is created by an electrode 26 in accordance with well-known plasma gun operation to create a plasma flame 28, resulting in a conical plasma jet 44 exiting the plasma gun 20 that expands outward toward the substrate 12. An example of a suitable plasma gun 20 includes a Metco 7MB APS gun available from Sulzer Metco (Westbury, N.Y.).

The coating constituents 42 are introduced into the plasma jet 44, typically at or near the plasma flame 28, along with a carrier liquid through injection of a liquid/solid mixture 40, preferably a colloidal suspension. The liquid/solid mixture 40 may be stored in a tank 32 or other similar container prior to injection. The tank 32 is in fluid communication with a liquid injector 38 attached to the torch portion 24 of the plasma gun 20. A pump 34 forces the liquid/solid mixture 40 through tubing 36 or some other conduit for fluid flow, at which point it enters the liquid injector 38. The pump 34 is preferably a peristaltic pump so that the liquid/solid mixture 40 in the tubing 36 does not come into contact with the pump 34, reducing or eliminating the possibility of contamination of the mixture 40 by the pump 34. The flow rate of the liquid/solid mixture 40 can be varied depending on the percentage of solids mixed with the liquid. The liquid injector 38 is typically attached directly to the plasma gun 20, which may be by way of any attachment device, such as a bracket 27 or other device that fixes the liquid injector 38 to the plasma gun 20. The solid/liquid mixture 40 is injected into the plasma flame 28 by the liquid injector 38 through an atomization nozzle 39. The liquid of the solid/liquid mixture 40 is vaporized and the thermal barrier coating constituents 42 in the liquid/solid mixture 40 entering the flame 28 are melted and are carried by the force of the plasma jet 44 (illustrated as bounded by the area within the broken lines) against the substrate 12 to form the thermal barrier coating system 14.

The substrate 12 is any article having a surface to which it is desired to apply a coating and the substrate 12 is constructed of any material to which a coating may be applied. Preferably, the substrate is an aircraft turbo-machinery component, such as a component of an aircraft turbine engine, for example. Where the substrate is a component of an aircraft engine, the substrate typically comprises a nickel-, iron- or cobalt-based superalloy or a ceramic material such as a SiC composite or the like.

It will be appreciated that a thermal barrier coating system 14 may comprise several layers, including a bond coat applied directly to the surface of the substrate 12, followed by an environmental coat overlying the bond coat, and a ceramic top coat, such as yttrium-stabilized zirconia (YSZ) applied over Pt(Ni)AI or MCrAlX, for example, where M is an element selected from the group consisting of Fe, Ni, Co and combinations thereof and X is an element selected from the group consisting of Y, Zr, Hf, Ta, Pt, Pd, Re, Si and combinations thereof. Thus, the materials used for the coating constituents 42 in the liquid injection plasma spray techniques according to exemplary embodiments of the invention may be selected depending on what layer of the thermal barrier coating system 14 is desired to be deposited on the substrate 12.

The thermal barrier coating constituents 42 are solid particles and can be any suitable materials for use in forming a barrier coating. Exemplary materials include metal, ceramic, or polymeric materials or combinations thereof. Preferably, the thermal barrier coating constituents 42 of the top coat of a thermal barrier coating system 14 include YSZ, but may also include Al₂O₃, mullite, silicon carbide, and glass frits, by way of example only. To assist in matching thermal expansion and to increase thermal conductivity, any metal-based material may also be included. The constituents 42 are less than 200 mesh, i.e. less than about 74 microns. To achieve a high density in the applied coating, the constituents 42 are very fine, preferably less than about 10 microns, more preferably less than about 1 micron in size.

The carrier liquid of the liquid/solid mixture can be water, an alcohol or any other organic solvent or combinations of these liquids. However, it will be appreciated that due to the extreme temperatures of the plasma flame 28, typically about 6,000 to about 15,000 degrees Celsius, suitable precautions should be taken to avoid potentially explosive conditions resulting from the use of a carrier liquid other than water.

The solid thermal barrier coating constituents 42 are preferably suspended in the carrier liquid, such that the liquid/solid mixture 40 is a suspension of the thermal barrier coating constituents 42. More preferably, the suspension is a colloidal suspension, such as the colloidal silicas available under the trademark Ludox® from the Grace Davison Company of Columbia, Md., for example. The thermal barrier coating constituents 42 should be less than about 75% by weight of the suspension, preferably between about 20% to about 40% by weight, although it will be appreciated that these amounts may vary depending on the density of the particular coating constituents 42 and carrier liquid selected.

According to a presently preferred embodiment of the invention for use in applying a thermal barrier system to a substrate, the coating constituents 42 include YSZ particles suspended in water, where the constituent particle size is fine enough to form a colloidal suspension.

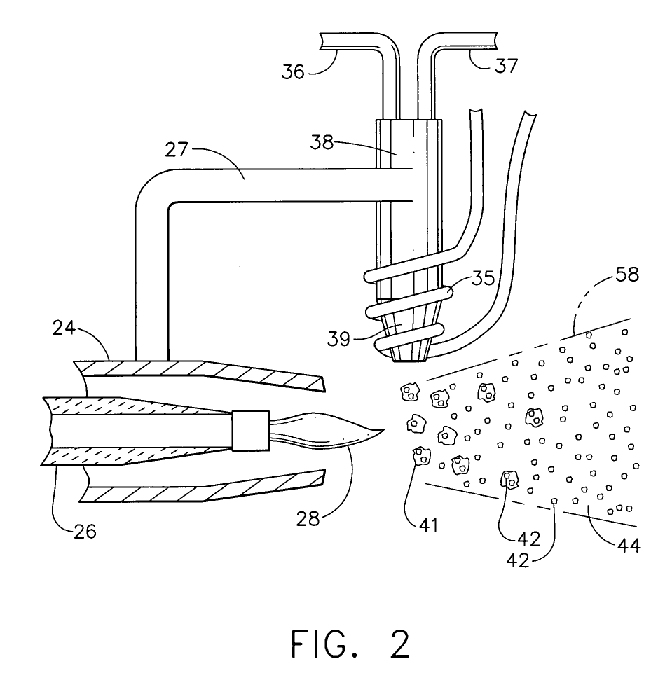

The extreme heat from the plasma flame 28 causes the carrier liquid to vaporize and dissociate, leaving the coating constituents 42 which are heated above their melting temperature and carried away by the plasma jet 44. FIG. 2 illustrates an enlarged view of the torch portion 24 of the plasma gun 20 in which the solid/liquid mixture is a suspension.

After the suspension enters the liquid injector 38 via the tubing 36, the suspension is atomized. Atomization can be accomplished by introducing an inert gas into the liquid injector 38 through an inert gas conduit 37 from an inert gas source (not shown) and passing the suspension and inert gas through an atomization nozzle 39. However, any method of atomization may be used, including, for example, an airless spray nozzle in which the pressure of the fluid itself is used to atomize the liquid/solid mixture 40. Upon exiting the atomization nozzle 39, the suspension enters the plasma jet 44 as atomized droplets 41. Each droplet 41 is a micro-suspension with coating constituents 42 suspended in the carrier liquid of the droplets 41. As a result of atomization, the droplets 41 have a large surface area to mass ratio, corresponding to excellent heat transfer. The heat of the plasma flame 28 causes the carrier liquid to evaporate and melts the coating constituents 42 which remain. The coating constituents 42 are carried away by the plasma jet 44 and deposited to form the thermal barrier coating system 14 on the substrate 12.

While not wishing to be bound to any particular theory, it is believed that the carrier liquid, upon entry into the plasma jet 44 and being exposed to the extreme heat associated therewith, not only evaporates, but also dissociates into its elemental components—hydrogen and oxygen in the case of water as carrier liquid.

The mass of the droplets 41 is sufficient to overcome the resistance at the boundary layer (illustrated by a phantom line 58) of the plasma jet 44 and propel the droplets into the plasma jet 44. The dissociation of the carrier liquid once in the plasma jet 44 dissipates the energy of the droplets 41 leaving the liquid injector 38. This dissipation of energy reduces the likelihood that the droplets 41 and/or the coating constituents 42 suspended therein will retain sufficient energy to pass completely through and out of the plasma jet 44. In a corresponding manner, this increases the likelihood that coating constituents 42 leaving the liquid injector 38 will end up as part of the coating of the barrier system 14 and will not be lost to the surrounding environment

The liquid injector 38 is typically positioned within an inch of the plasma flame, subjecting the atomization nozzle 39 to extreme heat. To reduce heat effects, means for cooling the atomization nozzle 39 may be used, such as a cooling jacket or cooling coil. As shown in FIG. 2, a copper cooling coil 35 is wrapped around the atomization nozzle 39. Chilled water or other liquid coolant passes from a coolant source (not shown) through the coil 35 to conduct heat away from the atomization nozzle 39 to a heat sink (also not shown).

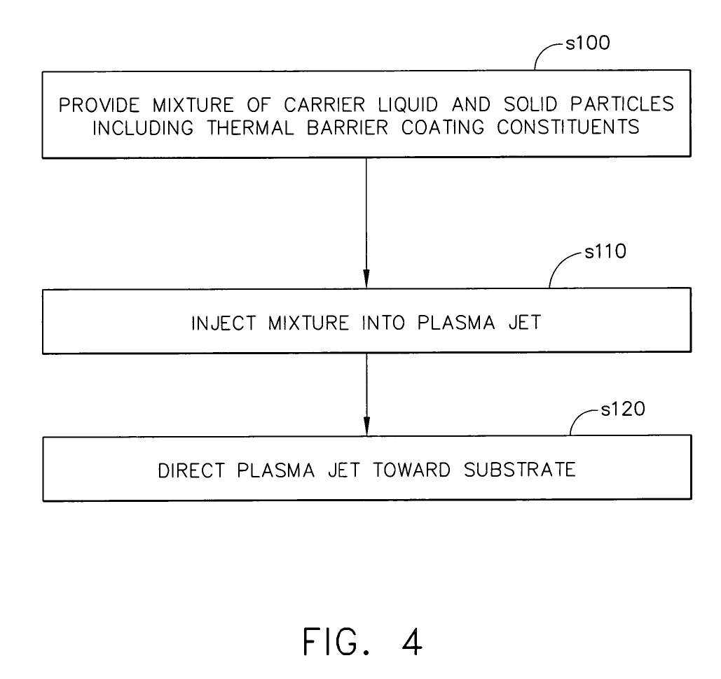

A method for applying a plasma sprayed coating to a substrate is diagrammatically shown by the box diagram of FIG. 4. The first step, as shown at s100, is to provide a liquid/solid mixture of a carrier liquid and solid particles including thermal barrier coating constituents. As previously discussed, the liquid/solid mixture is preferably a carrier liquid having the thermal barrier coating constituents colloidally suspended therein. The mixture is then injected into the plasma jet of a plasma spray gun at s110. The heat of the plasma jet melts the solid particles and carries them away in an expanding plume. The coating is applied by directing the plasma jet toward a substrate at s120. As a result, the melted constituents are carried away from the liquid injector by the expanding plume of the plasma jet and are deposited as a gradient film on the substrate. As each of the constituents cools on the substrate, a layer of constituent material is built up on the surface of the substrate providing a thermal barrier coating.

The coating constituents are typically applied at a distance of about 1 inch to about 6 inches from the substrate in a conventional manner. It will be appreciated that the farther the plasma gun is from the substrate, the wider the area to which coating constituents will be applied, although the rate at which the thickness of the coating grows will decrease in a corresponding manner. Coatings may be applied to any desired thickness depending on the component to be coated and that component's intended end use. Typically, the liquid injection based coating is applied at a pass rate of about 1 mil per pass to achieve a thickness of about 3 mils to about 45 mils when the coating is a thermal barrier coating for components of aircraft turbo-machinery.

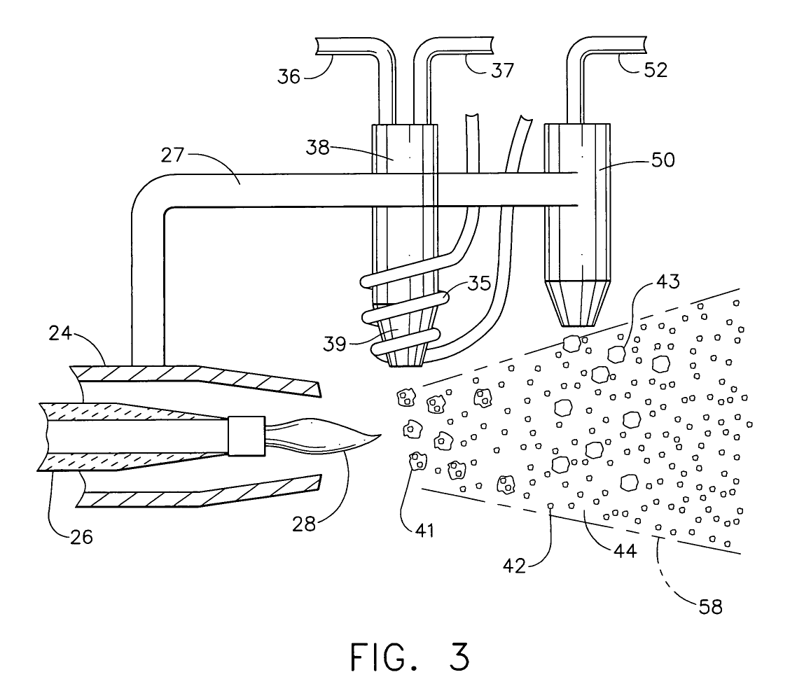

According to another exemplary embodiment of the invention, a conventional powder injector is used in combination with the previously described liquid injector 38. As shown in FIG. 3, a powder injector 50 is added to separately inject particulate thermal barrier coating constituents 43 directly into the plasma jet 44. The powder injector 50 can be any type of powder injector as is known in the art such as a gravity feed injector. As shown in FIG. 3, a powder injector 50 includes a powder injector conduit 52 connected to a feed source (not shown) from which particulate thermal barrier coating constituents 43 are introduced entrained in an inert carrier gas. These particulate thermal barrier coating constituents 43 are typically 200 mesh or larger particle size.

As previously discussed, using liquid injection to introduce thermal barrier coating constituents 42 into the plasma jet 44 as solid particles in a carrier liquid results in denser coatings. By combining the liquid-injected fine particles with larger particles injected by a separate direct powder feed, it is expected that the larger particles will enhance the deposition rate, such as up to about 3 mils or more per pass, increasing the rate of deposit while still providing a fine grain, dense coating.

The thermal barrier coating constituents 42 of the liquid/solid mixture 40 used in the liquid injector 38 may be either the same as or different from the particulate thermal barrier coating constituents 43 used in the powder injector 50. By varying the composition of the thermal barrier coating constituents introduced by the two different types of injectors, it is expected that mixed barrier coatings will be produced that are not achievable using conventional layering techniques.

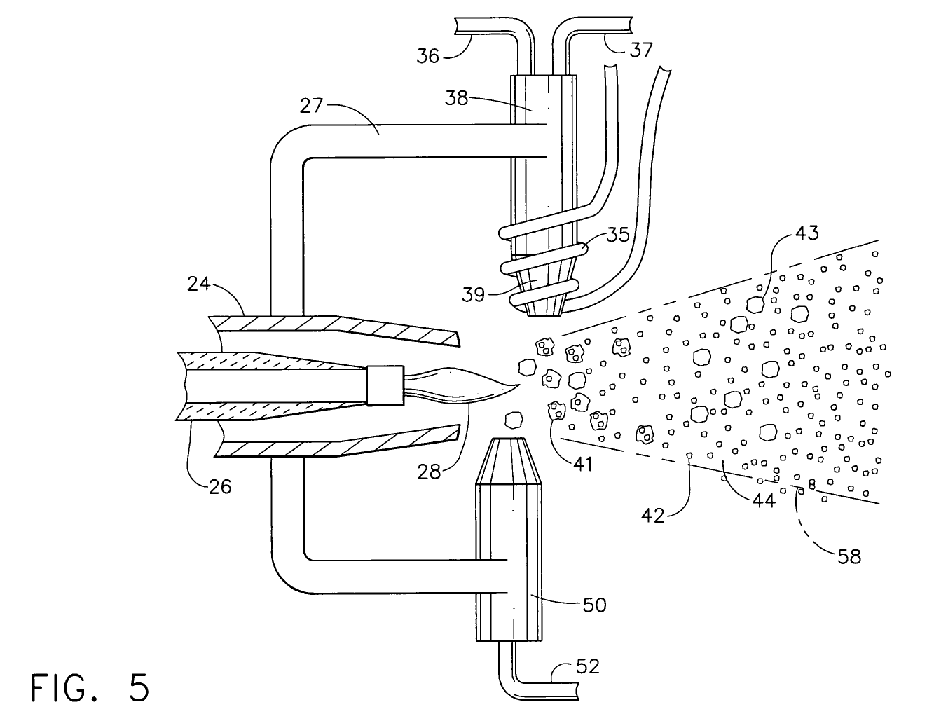

Although FIG. 3 illustrates the powder injector 50 positioned with respect to the liquid injector 38 to inject the particulate coating constituents 43 into the plasma jet 44 downstream from the liquid injector 38, the injectors 38, 50 may be arranged in any order or they may be arranged so that both the liquid injector 38 and the powder injector 50 separately introduce thermal barrier coating constituents into the plasma jet 44 at approximately the same position, as shown in FIG. 5. As shown in FIG. 5, multiple liquid and/or powder injectors may be positioned about the plasma stream 44 such that the injections are introduced into the plasma jet 44 in an opposing or cross-streaming manner that may further aid in getting the maximum amount of thermal barrier coating constituents 42 into the plasma jet 44.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for applying a plasma sprayed coating to a material comprising:
providing a substrate, the substrate having a surface;
providing a suspension comprising a carrier liquid and solid particles suspended therein, the solid particles including thermal barrier coating constituents;
injecting the suspension into a plasma jet of a plasma spray device; and
directing the resulting plasma jet toward the substrate surface to deposit a gradient film formed from the constituents onto the substrate surface.

2. The method of claim 1, wherein the thermal barrier coating constituents in the provided suspension have a particle size smaller than 74 microns.

3. The method of claim 1, wherein the thermal barrier coating constituents in the provided suspension have a particle size smaller than about 10 microns.

4. The method of claim 1, wherein the thermal barrier coating constituents in the provided suspension have a particle size smaller than about 1 micron.

5. The method of claim 1, wherein the carrier liquid of the provided suspension is selected from the group consisting of water, an alcohol, organic solvents and combinations thereof.

6. The method of claim 1, wherein the thermal barrier coating constituents in the provided suspension are a material selected from the group consisting of a metal, a ceramic, a polymer, and combinations thereof.

7. The method of claim 1, wherein the thermal barrier coating constituents in the provided suspension comprise yttrium-stabilized zirconia.

8. The method of claim 1, wherein the provided suspension comprises up to about 75% by weight solid particles.

9. The method of claim 1, wherein the provided suspension comprises about 20% to about 40% by weight solid particles.

10. The method of claim 1, wherein the provided suspension is a colloidal suspension.

11. The method of claim 1, wherein the provided suspension comprises yttrium-stabilized zirconia suspended in water.

12. The method of claim 1, further comprising the step of separately injecting particulate thermal barrier coating constituents into the plasma jet of the plasma spray device.

13. The method of claim 12, wherein the particulate thermal barrier coating constituents are comprised of a different composition than the suspended thermal barrier coating constituents.

14. A method for applying a plasma sprayed coating to a material comprising:
providing a substrate, the substrate having a substrate surface;
providing a liquid/solid mixture comprising a carrier liquid and solid particles intermixed therewith, the solid particles including thermal barrier coating constituents;
providing particulate thermal barrier coating constituents other than in a liquid/solid mixture;
separately injecting the liquid/solid mixture and the particulate thermal barrier coating constituents into a plasma jet of a plasma spray device; and
directing the resulting plasma jet toward the substrate surface to deposit a gradient film formed from the constituents onto the substrate surface.

15. The method of claim 14, wherein the liquid/solid mixture is a suspension.

16. The method of claim 14, wherein the liquid/solid mixture is a solution.

17. The method of claim 14, wherein the thermal barrier coating constituents in the provided liquid/solid mixture have a particle size smaller than about 10 microns and wherein the particulate thermal barrier coating constituents have a particle size larger than about 74 microns.

18. The method of claim 14, wherein the provided liquid/solid mixture comprises about 20% to about 40% by weight solid particles.

19. The method of claim 14, wherein the carrier liquid of the provided liquid/solid mixture is selected from the group consisting of water, an alcohol, organic solvents and combinations thereof; and
wherein the thermal barrier coating constituents in the provided liquid/solid mixture are a material selected from the group consisting of a metal, a ceramic, a polymer, and combinations thereof.

20. A device for applying a thermal barrier coating system to a substrate comprising:
a plasma gun having a passage for the flow of a plasma-forming gas therethrough and an electrode disposed in the passage, the electrode configured to create an electric arc sufficient to heat the plasma-forming gas to a temperature that causes a change of state in the plasma-forming gas to create a plasma jet upon exiting the plasma gun;
a liquid injector configured to inject a suspension of a carrier liquid and solid particles comprising thermal barrier coating constituents into a plasma jet exiting the plasma gun; and
a powder injector configured to inject particulate thermal barrier coating constituents entrained in an inert gas into the plasma jet exiting the plasma gun.
